(19) United States
(12) Patent Application Publication
(10) Pub. No.: US 2002/0116464 A1
(43) Pub. Date: Aug. 22, 2002

(54) Electronic communications system and method

(76) Inventor: Joon Mun Mak, Singapore (SG)

Correspondence Address: Robert D. Kucler, Esquire, REED SMITH LLP, P.O. Box 488, Pittsburgh, PA, 15230-0488, US

(21) Appl. No.: 09/818,165

(22) Filed: Mar. 27, 2001

Related U.S. Application Data
(60) Provisional application No. 60/270,261, filed on Feb. 20, 2001.

(51) Int. Cl. G06F 15/16; H04M 11/00

(52) U.S. Cl. 709/206; 709/245; 379/93.24; 379/100.15

(57) ABSTRACT

A system and method for electronic communications; more specifically, a system and method for transmitting real-time or non-real-time voice and facsimile electronic data across both circuit-switched and packet-switched networks. The system may include a gatekeeper server capable of communicating with a system subscriber across a packet-switched network and a network node capable of communicatively interconnecting a circuit-switched network, such as the Public Switched Telephone Network (PSTN), and a packet-switched network utilizing the Internet Protocol for transmission. If a subscriber is not available to receive an electronic communication at his primary telephone number or IP address, the system may be capable of re-directing the communication to additional telephone numbers or IP addresses across either the circuit-switched or packet-switched networks, according to the subscriber's preferences. The system may also include media servers, databases, notification servers, and other hardware and software to impart functionality to the communications system. A subscriber to the system is preferably identified by a single subscriber identifier, which may be associated with the subscriber's dynamic IP address, and is able to send and receive voice calls, facsimiles, and other electronic messages to and from both subscribers and non-subscribers on the same or other communications networks. The system may also provide for non-real-time voice messaging in the event an immediate direct connection is not available or desired. The system components are preferably designed to be scalable, redundant and adapted to be replaced and upgraded while the system is running.

This application claims the benefit of the earlier filing date of provisional application No. 60/270,261 filed on Feb. 20, 2001.

### FIELD OF THE INVENTION

The present invention relates to systems and methods for electronic communications and, more particularly, relates to systems and methods for transmitting and storing voice, facsimile or other data across both circuit-switched and packet-switched communications networks.

### BACKGROUND OF THE INVENTION

The conventional telecommunications landscape is centered around the Public Switched Telephone Network (PSTN). The PSTN is a series of local communications networks interconnected to each other directly and through a wide-ranging long distance telephone network. Generally, a caller places a call from a telephone or other electronic communications equipment (telephonic device), and the call data travels over copper twisted pair or other low bandwidth medium to a local telephone switch serving a local community of telephone users (the “local loop”) where it is received by a telephone line card.

If the caller is attempting to reach another person who is part of the same local telephone network, the local switch usually will route the call directly back to the callee and ring his or her telephone, completing the telephonic loop with the callee's copper twisted pair. If, on the other hand, the caller is attempting to contact a person on another local network (or even in another country), the caller's local switch will typically transfer the call to the long distance telephone system, which interconnects the various local switches using large bandwidth (high volume) communications channels such as fiberoptic cable, and route the call to the callee's local telephone switch. The callee's local switch may then take the call off of the long distance network and route the call to the correct callee telephone or other device. The routing of the call is generally guided by the telephone number (country code, area code, local exchange, and direct number) according to the Signaling System 7 (SS7) or some other transmission protocol.

The PSTN is generally a circuit-switched communications network. As such, the entire bandwidth of the system is divided into smaller segments of bandwidth called “channels” upon which calls are transmitted. As calls are received by the system, each call is allotted a specific channel and utilizes the full bandwidth within that channel for the duration of that call, even during times when the parties to the call are not speaking. New calls are assigned to additional channels as the calls are received until the entire bandwidth of the system is exhausted. Thereafter, the next caller will receive a “circuit busy” signal indicating that the system is full. Therefore, as new callers utilize the system, these new callers may receive a “circuit busy” signal, but additional users generally will not degrade the fidelity of any of the telephone calls.

This circuit-switched system is somewhat inefficient because a caller may not utilize the entire bandwidth of his or her assigned channel throughout the conversation. Specifically, the same channel bandwidth is utilized whether or not the parties to the conversation are currently speaking. Valuable bandwidth, that could be used for other calls, is wasted.

With the creation of the World Wide Web (WWW) and web-specific applications, the Internet has exploded into a global network of research, business, and personal users. The Internet is generally a collection of smaller data networks utilizing the Internet Protocol, or “IP,” transmission format. Unlike the circuit-switched architecture of the PSTN, IP networks are data packet networks (packet-switched) networks. The computers on the network are interconnected by persistent connections, the bandwidth of which is shared by all active users. Specifically, as opposed to assigning a predefined amount of the network's bandwidth (a channel) to each user, all of the users on the system send packets of information across the medium as needed. When a user is not sending or receiving data, that particular user does not waste any bandwidth. As the network gets busier, each user will remain connected but may experience performance degradation (due to increased data traffic). IP has become the de facto standard for data networking, but new transmission protocols are always being defined.

The rise of IP-based data communications and the recent global market liberalization have changed the traditional telecommunications landscape. IP presents the ability to converge existing telephony systems and data networks into a single communication medium. IP may become the future global network for voice, fax, and data communications by providing a seamless, worldwide connectivity solution between voice and data networks.

Traditional telephonic communications systems are becoming more accessible to innovation. In the United States, Europe and Asia, including Korea, Japan, Hong Kong and Singapore, governments are deregulating aspects of the telecommunications industry to allow more people to utilize these vast communications networks. Deregulation provides broader, cheaper access to the PSTN, encouraging communications innovation.

Additionally, the IP world itself is growing at an incredible pace. More users are getting “wired” everyday, and Internet users are utilizing the medium in growing ways. Also, wireless IP applications, such as Personal Digital Assistants (PDAs) and IP-enabled pagers, are being utilized by a growing number of people. Soon, analysts predict, the IP network will be larger than the traditional telecommunications networks. The present invention attempts to utilize advantages of both of these networking technologies to develop an integrated data communications system.

Although the PSTN and IP networks are fundamentally different in terms of routing and performance, it is possible for the networks to be interconnected, exchanging voice and data traffic. Voice over Internet Protocol (VoIP or V/IP) is an example of telephonic technology that utilizes both network types. In VoIP, a voice signal is converted into compressed data packets that are sent by IP to a receiving destination where the packets are decompressed and reassembled. The service providers on both ends of the call communicate with their respective IP telephony switches using ISDN, T1 and/or E1 connections, which include both the voice and the signaling information. On the IP networks, users send and receive voice data using an IP telephony terminal, which is typically a multimedia IP device equipped with telephony software.

Although certain VoIP systems allow voice calls to be placed between two multimedia devices, or even from a multimedia device to a traditional telephone, the use and flexibility of these systems is limited. For example, because of the lack of fully defined standards, prior VoIP products generally require that network nodes (which connect the PSTN to the IP network) from the same vendor exist on both sides of the IP network. Additionally, these prior systems do not allow a single subscriber identifier (telephone number) to be used to call a person on their IP device (PC) as well as on their landline telephone or other communications device. Prior VoIP systems may not offer voice mail and facsimile features.

These various limitations to the current implementation of VoIP communications are preferably improved in relation to the prior art through the use of the current invention. These and other objects and advantages of the present invention will become readily apparent to persons skilled in the art from the following description of a particularly preferred embodiment.

### SUMMARY OF THE INVENTION

In accordance with the present invention, there is provided a system and method for electronic communications; more specifically, a system and method for transmitting voice and facsimile electronic data across both circuit-switched and packet-switched networks is provided. The system preferably includes a gatekeeper server capable of communicating with a system subscriber across a packet-switched network and a network node capable of communicatively interconnecting a circuit-switched network, such as the PSTN, and a packet-switched network, such as the Internet, which utilizes the Internet Protocol for transmission. The system may also include client software running on a multimedia IP device that enables a subscriber to interact with the gatekeeper.

A subscriber to the system is preferably identified by a single subscriber identifier, which is preferably a telephone number that corresponds to the dialing practices of the local PSTN telephone exchange to which the subscriber is connected. By directing a communication to this subscriber identifier or to a traditional PSTN telephone number, the system allows voice calls, facsimiles, and other electronic messages to be sent to and received from both subscribers and non-subscribers on the same or other communications networks. This system preferably enables four types of seamless communications: (1) IP device to IP device; (2) IP device to telephonic device; (3) telephonic device to IP device; and (4) telephonic device to telephonic device.

If a subscriber is not available to receive an electronic communication at his primary telephone number or IP address, the system (via the network node) may be capable of re-directing the communication to additional telephone numbers or IP addresses across either the circuit-switched or packet-switched networks, according to the subscriber's preferences. For example, if a call is placed to a user's subscriber identifier (subscriber number) and that user is not logged into the packet-switched network (e.g., the Internet), the network node may switch the call out over the PSTN and ring the same user on his landline phone or mobile telephone. This switching is enabled because the system determines a user's dynamic IP address when the user logs into the system and associates this IP address with the subscriber identifier in a database. Preferably, this multi-network switching is seamless to the caller, whether the caller places the initial call from a regular telephone or an IP device.

The IP communications system may also include media servers, databases, notification servers, and other hardware and software to impart functionality to the communications system. The system may provide for non-real-time voice messaging (e.g., voice mail) in the event an immediate direct connection is not available or desired. The system network nodes may also recognize incoming fax messages and store/replay these messages according to user preferences. The system components are preferably designed to be scalable, redundant and adapted to be replaced and upgraded while the system is running.

### BRIEF DESCRIPTION OF THE DRAWINGS

The present invention and its presently preferred embodiments will be better understood by reference to the detailed disclosure hereinbelow and to the accompanying drawings, wherein:

FIG. 1 is a high level block diagram of one embodiment of the present invention;

FIG. 2 is a system architecture block diagram of one embodiment of the present invention;

FIG. 3 is a functional diagram of one embodiment of a network node;

FIG. 4 is a functional diagram of one embodiment of the present invention;

FIG. 5 is a detailed description of one embodiment of a network node;

FIG. 6 is a functional diagram of the hardware and software on the multimedia software client running on an IP device; and

FIG. 7 shows a representation of one user interface of the present invention.

### DESCRIPTION OF THE PREFERRED EMBODIMENTS

IP telephony, the technology that enables telephony-based applications and devices to use existing data networks via the Internet Protocol, is creating dramatic changes in the telecommunications industry. IP telephony represents the convergence of circuit-switched networks, such as the traditional Public Switched Telephone Network (PSTN) and leased T1 and E1 lines, with packet-switched networks, such as the Internet or local intranets. The IP communications system of the present invention generally utilizes a network node, a gatekeeper and a multimedia software client running on one or more IP devices to enable interoperability of these two disparate network types and to support communication connections between telephones, fax machines, other telephonic devices and multimedia IP devices. The present system generally facilitates four communications schemes: telephonic device to telephonic device; telephonic device to IP device; IP device to telephonic device, and IP device to IP device.

The present invention broadly contemplates, in at least one preferred embodiment, a system and method for sending, receiving, and/or storing electronic messages over both a circuit-switched network and a packet-switched network. To aid in the comprehension of the present invention, the description of the preferred embodiments is parsed into three discrete sections. Initially, a general system overview will provide a high level description of certain preferred features and elements of the invention. Next, a more detailed discussion of the hardware and software system architecture will provide a more finite understanding of the invention. Finally, a series of examples of use of at least one preferred embodiment will be presented to tie all of the described features together. It should also be noted that the physical structure and certain programming techniques utilized in the network nodes, gatekeeper, client software and other devices of the present invention are based, in part, on existing VoIP technology well-known in the art.

1. System Overview

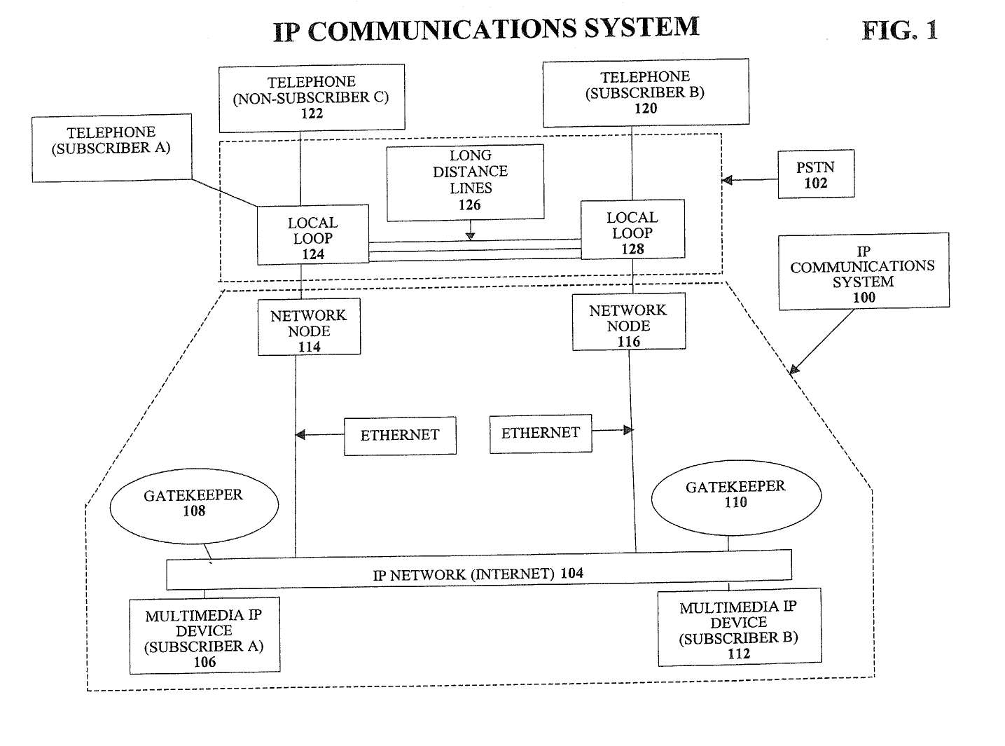

The IP communications system of the present invention generally allows a subscriber to the system to exchange electronic communications with other people across disparate communications networks. This functionality may allow both subscribers to the system and non-subscribers to communicate with each other in a variety of ways according to FIG. 1. As shown in FIG. 1, the IP communications system 100 uses one or more network nodes 114, 116 to interconnect the Public-Switched Telephone Network 102 with an IP network 104 such as the Internet. When placing or receiving calls from an IP device (e.g., a multimedia personal computer 106), the subscriber utilizes client software that communicates with a gatekeeper server 108 which is the user's entry point into the IP communications system 100. The gatekeeper 108 can interact with the network node 114.

In one example, a caller who is a subscriber A to the system 100 may place a “telephone” call to a “callee” subscriber B of the system 100 via the caller's multimedia IP device 106. A gatekeeper server (gatekeeper) 108, assigned to caller A, in the system 100 preferably analyzes the placed call and determines whether or not callee B is a subscriber to the IP communications system 100.

Because, in this case, the callee B is a subscriber, the gatekeeper 108 may poll a system database (not shown) to determine the dynamic IP address of the callee subscriber B. If the callee B is logged onto the Internet, the callee's gatekeeper 110 may poll the callee's IP device 112 and authenticate the callee B as the intended second party to the call. After authentication, the gatekeeper 108 preferably signals to the caller's client 106 and the callee's client 112 to set up a telephone call (utilizing H.323 or some other call protocol) between the two subscribers. This call will preferably take place exclusively over the IP network 104 without any data traveling out over the PSTN 102. This is an IP device 106 to IP device 112 call.

If the callee subscriber B was not logged in or was not available at his or her IP device 112, the IP communications system 100 may have the capability to redirect the incoming call to the callee's mobile telephone, landline phone, pager, or some other communications device 120 (preferably over the PSTN 102) according to the callee's preconfigured preferences. In this way, the callee's single “subscriber identifier” (which may be a telephone number) allows calls to “follow” the callee B to other communications devices 120, thereby increasing the likelihood that the callee B receives the “telephone” call. If the callee's mobile phone, pager and/or other devices 120 are connected to the PSTN 102 (which is most likely the case), the callee's network node 116 will preferably convert and redirect the call data from the packet-switched IP network 104 to the circuit-switched PSTN 102. As the call proceeds, the voice data must be continually converted back and forth among these two disparate networks 102, 104, perhaps utilizing encryption technology. This is an IP device 106 to telephonic device 120 call.

If the callee B still cannot be found, or if the callee's preferences so state, the IP communications system 100 may also have voice mail or other messaging capabilities that prompt the caller A to record a spoken message for the callee B's later retrieval. Again, the callee B may be notified of this waiting message in a variety of ways. Thereafter, the caller B may retrieve his voice mail message using an IP device or from a regular PSTN-based telephone.

In another scenario, the subscriber caller A may attempt to communicate with a non-subscriber C by placing a call from his or her IP device 106 to the callee's telephone 122 (via the callee's PSTN telephone number). When the subscriber caller A places the call on his or her multimedia IP device 106, the gatekeeper 108 will again preferably check a registration database to see if the intended callee C is a subscriber. In this case, the gatekeeper 108 will confirm that the callee C is not a subscriber, and the gatekeeper 108 will signal to the network node 114 to place the call on the PSTN 102 rather than internally on the IP network 104. The network node 114 will preferably transfer the call out to the PSTN 102 and the non-subscriber callee's telephone 122 (or other device) will ring according to conventional telephone practices. From the caller A's point of view, the network node's 114 routing of the call should be substantially seamless, and the caller A should not be able to tell whether the call was transferred or not. This is an example of an IP device 106 to telephonic device 122 call.

Because the single “subscriber identifier” (which is preferably a telephone number) is a convenient way to locate a person, and further because the network node may route the call to “follow” the subscriber when he or she is away from his or her IP device, both subscribers and non-subscribers may call subscribers from regular telephones. For example, a non-subscriber caller C may call a subscriber B via his or her subscriber number. The subscriber number preferably corresponds to the local dialing practices of the PSTN 102 at the subscriber's geographic location (e.g., country code, area code, local exchange). Therefore, the PSTN 102 will route the dialed call from the caller's local loop 124 and across the long distance lines 126 to the local telephone network 128 that corresponds to the subscriber number. The IP communications system network node or nodes 116 attached to that local telephone loop 128 will preferably recognize the subscriber telephone number as belonging to a subscriber and transfer the call from the PSTN 102 to the IP-switched network 104. The gatekeeper 110 will then preferably determine the dynamic IP address of the callee subscriber B (from a database) and ring his IP device 112. If the callee B is connected to the IP network 104 and is properly authenticated, the network node 116 preferably sets up the telephone call from the non-subscriber C to the subscriber B. This is an example of a telephonic device 122 to IP device 112 call.

Again, if the callee subscriber B is not available to receive the Internet call, the call may be redirected by the network node 116 out of the system (over the PSTN 102) to locate the subscriber B on a different communications device 120. In this case, the call would now continue over only the PSTN 102. The call would travel like a regular telephone call from the caller C's telephone 122, out to the caller C's local loop 124, across long-distance lines 126, to the callee B's local loop 128, and finally to callee B's telephone 120. This is an example of a telephonic device 122 to telephonic device 120 call.

If the non-subscriber callee C leaves a voice mail message for the subscriber B, the subscriber B may have the ability to “call” the system 100 from an outside line (e.g., from telephone 120) over the PSTN 102 and receive his voice mail, as is the conventional voice mail practice. Preferably, the subscriber B would dial his or her subscriber number and use a touch-tone keypad to navigate through various levels of electronic voice mail command menus to retrieve his messages.

Because a call may be placed from an IP device or from a conventional telephone, and a call may be directed toward an IP device or switched out to the PSTN, the present invention preferably allows four types of completed calls and data communications: (1) IP device to IP device; (2) IP device to telephonic device; (3) telephonic device to IP device; and (4) telephonic device to telephonic device.

In addition to voice traffic, the IP communications system 100 of the present invention also preferably supports facsimile and other data communications transfers. For example, the network node 114, 116 may have the capability automatically to detect the “squelch” or calling tone (CNG) of an incoming fax transmission and return the proper tones to the sender to set up a fax transmission. The network node 114, 116 preferably directs the incoming fax to a database for temporary storage and notifies the subscriber that a fax is waiting on the system for retrieval.

2. Detailed System Architecture

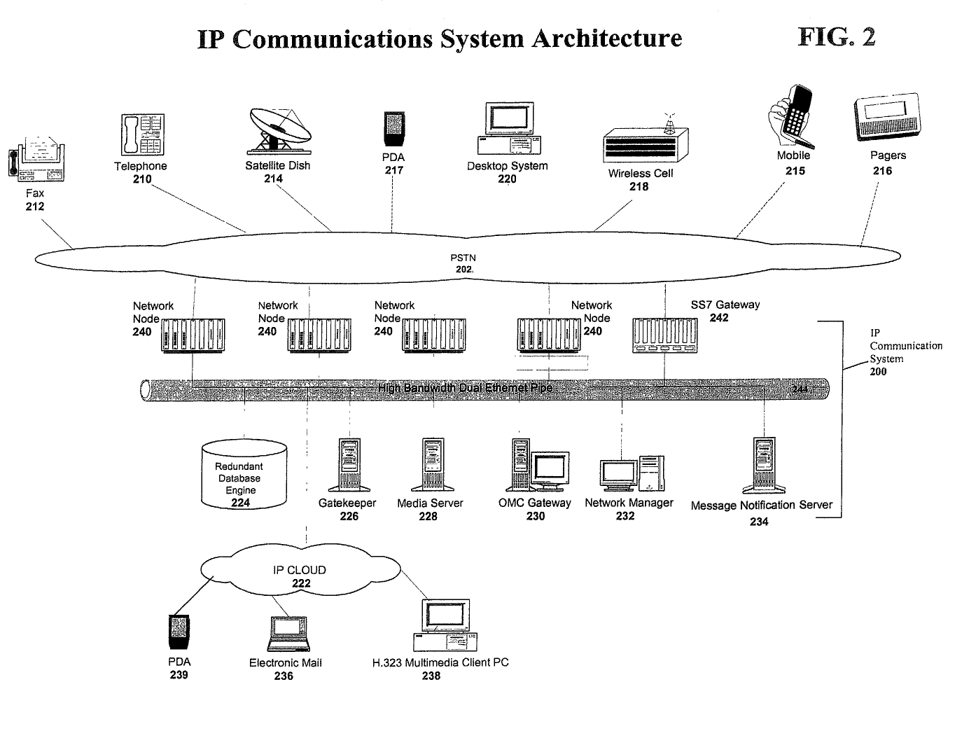

FIG. 2 generally depicts a sample system architecture for the present invention including the IP communications system 200. The system 200 generally works in conjunction with a circuit-switched communications network 202, such as the Public Switched Telephone Network (PSTN). The PSTN 202 is connected to a series of electronic communications devices 210-220 through various transmission mediums, both wired and wireless, included in the PSTN 202. For example, FIG. 2 includes a telephone 210 and fax machine 212 for sending voice and graphics over the PSTN 202. There may also be a satellite dish 214 or other large-scale wireless communications systems. Wireless applications such as mobile telephones 215, voice and text pagers 216, and personal digital assistants 217 (PDAs) also utilize the conventional PSTN 202. These wireless devices often include a system of wireless “cells” 218 for routing and relaying calls to and from the PSTN 202. Finally, FIG. 2 shows a computer system 220 which may be connected to the PSTN 202 by way of a wired or wireless modem or other communications connection.

As described above, the PSTN 202 includes many “local loops” or local telephone systems that are connected together either directly (e.g., with a router or other gateway) or through high-speed long distance lines (e.g., fiberoptic cable or satellite links). By interconnecting the local loops, the large scale PSTN 202 seamlessly routes telephone calls and other communications across large geographical distances. For example, a user in one city may place a call from a telephone connected to his or her local loop (owned and/or operated by Company A) to a second user whose telephone is directly connected to a second local loop (owned and/or operated by Company B) in another city. That call may be switched from Company A's loop, across a third company's long distance lines, and finally to Company B's local loop. Because of the interconnectivity, the call switching appears seamless to the caller and the callee.

The lower half of FIG. 2 (the network nodes 240 and below) expands the communications capabilities of the PSTN 202 by interconnecting the PSTN 202 with a packet-switched network 222 such as the Internet or a local intranet. This additional packet-switched network 222 preferably works in communication with various servers (e.g., 226, 228) and databases 224 to form an IP communications system 200, capable of both transmitting information along the packet-switched network 222 and transferring information out to and in from the circuit-switched PSTN 202. The IP communications system's servers and databases may be interconnected via a transmission medium such as a high bandwidth Ethernet pipe 244 which is also connected to the packet-switched network.

One of these servers, the gatekeeper 226, is preferably connected to the public Internet or other packet-swtiched data communications network 222. The users of the IP communications system 200 preferably access the system by logging onto the Internet 222 through their Internet Service Provider (ISP) or other Internet connection mechanism (generally indicated as the IP cloud 222 in FIG. 2). The gatekeeper 226 has the functionality to identify these users on the Internet 222 and reroute their communication along the proper communications path.

The IP communications system 200 architecture also generally includes one or more network nodes 240 and/or SS7 gateways 242 connected between the IP network 222 and the PSTN 202. Because these networks 202, 222 are of two different types, (i.e., circuit-switched and packet-switched ) the network nodes 240 act as interpreters or interconnection computers that are capable of translating and rerouting signals to and from a circuit-switched network 202 (such as the PSTN) and a packet-switched network 222 (such as the Internet). The SS7 gateway 242 may be an interface between the network nodes 240 and the circuit-switched network 202 and may assist the network nodes 240 with call setup and signaling controls. Although much more detail will be given below, the network nodes 240 generally allow the interoperability of the two disparate network types 202, 222.

A subscriber to the IP communications system 200 is generally able to place and receive telephone calls from his IP device (e.g., 238) which includes system client software. The software client preferably runs on a multimedia IP device 238, which may include a CPU, and “multimedia components” such as a sound card, microphone, speakers, and/or a headset. These multimedia components aid the user in sending and receiving voice signals through the IP device 238. The multimedia IP device may be a stand-alone personal computer (PC) 238, a workstation, a wireless personal digital assistant (PDA) 239, an electronic mail device or other web appliance 236, or any other electronic communication device capable of performing telephony functionality according to a predefined call standard such as H.323, SIP, MGCP or other standard.

The IP device client 238 also includes client software, installed from a disk or downloaded from the Internet, that allows the subscriber to use the IP communications system 200. The client software enables communications between the IP device 236, 238, 239 and the gatekeeper 226, and provides the user with an intuitive graphical user interface (GUI) for utilizing the system. The client software may also provide certain functionality such as: call forwarding; call barring (“do not disturb”); direct callback; auto-registration; auto-upgrade; auto-verification of IP address; call “accept;” call “reject;” voice mail, fax and missed call notification and other features which are described in more detail below.

To log onto and utilize the IP communications system 200 the user preferably has a connection to the public Internet, a local intranet, or some other packet-switched communications network 222 that is also accessible to the gatekeeper server 226 of the IP communications system 200 (e.g., by way of a high bandwidth Ethernet pipe 244). This dial-up or other Internet connection is generally depicted as an “IP cloud” 222 in FIG. 2.

The gatekeeper server or “gatekeeper” 226 acts as the connection interface between the subscriber of the system (accessing the system through his or her IP device 236, 238, 239) and the remainder of the components (servers 228, databases 224, network nodes 240) of the system 200. The gatekeeper 226 is connected to the IP cloud 222 through a broadband communications medium, such as a fiberoptic cable 244. This communications medium is preferably a high bandwidth Ethernet pipe 244 as indicated in FIG. 2.

The network nodes 240 also preferably provide the voice mail facility so that when the callee is not available, the caller can leave a message for him or her. Each user who subscribes to the voice mail service is allocated a personal voice mail box. Users may call the network nodes 240 to access their voice mail messages. Faxes received by the IP communications system 200 also may be stored and transferred via FTP (file transfer protocol) by the gatekeeper 226 to the software client upon request (user gets notification that a fax is waiting).

The network node(s) 240 are the communication interpreters that allow the packet-switched network 222 just described to communicate seamlessly with a general circuit-switched communications network such as the PSTN 202. The network nodes 240 are generally capable of transferring both real-time voice communications and non-real-time messages (such as voicemail and/or facsimile) from one form of communications network (e.g., circuit-switched) to another (e.g., IP) and vice versa. The network node 240 may be redundant and scalable in that more than one network node 240 may be connected to each local loop or PSTN trunk.

The network node 240 hardware may include a high-end CPU such as is common in personal computers and/or workstations, hard disks, memory (RAM, ROM), as well as several IP telephony cards. Each telephony board preferably interfaces with T1/E1 PSTN trunk lines and a 100 base T interface (on the IP network 244 side). In a preferred embodiment, the network node includes the NMS CG6000 telephony board which allows for, at a minimum, 120 calls to be processed by the board at once. Each of the network nodes 240 may include four telephony boards for a total of 480 ports or 480 simultaneous inbound and outbound VoIP calls. If more ports are needed, additional network nodes 240 may be deployed. Preferably, the network node 240 will autodetect additional CG6000 boards (or other telephony boards) if they are present in the system. By default, the system 200 may automatically utilize all existing resources on every board. Alternatively, certain boards or ports may be reserved for emergency use or some other purpose.

With multiple boards, each network node 240 preferably supports up to 480 simultaneous calls. Voice over IP (VoIP) functionality is built into every port with a standard IP call control protocol such as H.323, MGCP or SIP. Supported codecs, for example, may include G711, G723, G726, and GSM.

The network nodes 240 also contain software that gives functionality to the VoIP telephony boards. The network node software, developed as part of the present invention, generally includes the following features: multi-threading core engine; telephonic device-to-IP device and IP device-to-telephonic device connectivity; interface to software client, subscriber database, gatekeeper databases, and notification server; voice/fax mail; IVR; network node-PSTN signaling; security control; and watchdog function. The network nodes 240 are preferably designed for scalability, portability, and ease of maintenance, so that the nodes can be serviced while still operational in the field. In one embodiment, the nodes 240 are developed using a common workstation operating system. The nodes 240 preferably support customizable call flow through a built-in scripting engine. The code base of the network nodes 240 preferably contains no operating system-dependent code, enabling the nodes 240 to be easily ported to another OS, as long as the NMS, API and RadVision H.323 API is supported by the new operating system.

Multiple other servers and computers may also be connected to the IP communications medium 244. These other servers and devices, as well as those already mentioned, may be implemented on the same computer, various separate computers or any subcombination thereof. For example, a redundant database engine 224 preferably exists as part of a computer connected to this medium 244. The redundant database engine 224 includes several databases that keep track of calls, subscriber identifiers, subscriber passwords and user preferences. The database 224 also preferably keeps track of the current (dynamic) IP address for system subscribers. Therefore, as subscribers log on and off of their ISP, changing their dynamic IP address, the system 200 updates its database records. This “dynamic” IP address for a current user is matched to the subscriber identifier for that user in the database. This dynamic IP address to subscriber identifier association in the system database preferably allows for subscriber authentication and call re-routing from the IP-switched network to the PSTN (explained in more detail below).

There may also be a media server 228 capable of storing and/or streaming multimedia information to the user in various circumstances. For example, the media server 228 may be able to store and play voice data in an electronic format such as “.wav” files. At a later time, the “.wav” files may be sent or streamed to the software client to allow the user to hear the voice mail or other multimedia messages. The media server 228 may also support other multimedia formats for audio (e.g., .mp3, .wav, .amf, and .rm) and video (e.g., MPEG, QuickTime). The media server 228 may be implemented on a conventional PC with software.

The system 200 may also include one or more “administrative” elements that aid the system administrator in tracking and monitoring system performance. These elements may include an On-line Monitoring Computer (OMC) 230 and/or a network manager 232. The OMC gateway 230 is preferably a piece of software that monitors the performance of all of the individual network nodes 240. The OMC gateway 230 typically tracks the network nodes 240 and tracks the number of calls each subscriber places and receives, the duration of these calls, how many trunks are available for additional calls to be placed, and other administrative features of the network. This traffic information may be useful in determining what percentage of system resources are generally being used, and may help the system administrators to determine the appropriate times to upgrade or replace hardware and software.

The network manager computer 232 may be the configuration element of the system 200. The network manager 232 may monitor the network node 240 or other system components, or receive monitored information from the OMC gateway 230, to determine at what point the system 200 is running at or near full capacity. When near full capacity, the network manager 232 may signal to the network nodes 240, 242 to cease accepting new calls. This network manager 232 may perform any number of administrative, configuration, and monitoring tasks.

The message notification server 234 preferably logs and tracks incoming calls and messages when the user is not able to be located. When the user logs onto the IP communications system 200, the message notification server 234 typically sends a message to the client software (on 238) that indicates how many and what types of messages are awaiting the user. For example, the notification server 234 may indicate that a caller called and did not leave a message—a missed call event—(indicating the caller's number or subscriber identifier). The notification server 234 may also indicate that a fax or voice mail was received and is waiting to be “picked up” by the user. Finally, the notification server 234 may indicate that a call was received and the caller left a voice mail message. These indications are useful for the user because they give the user a complete indication of activity since the last time the user logged onto the IP communications system 200. The client software may provide further choices of future user actions based on these received notifications (e.g., automatic call back, fax/message retrieval).

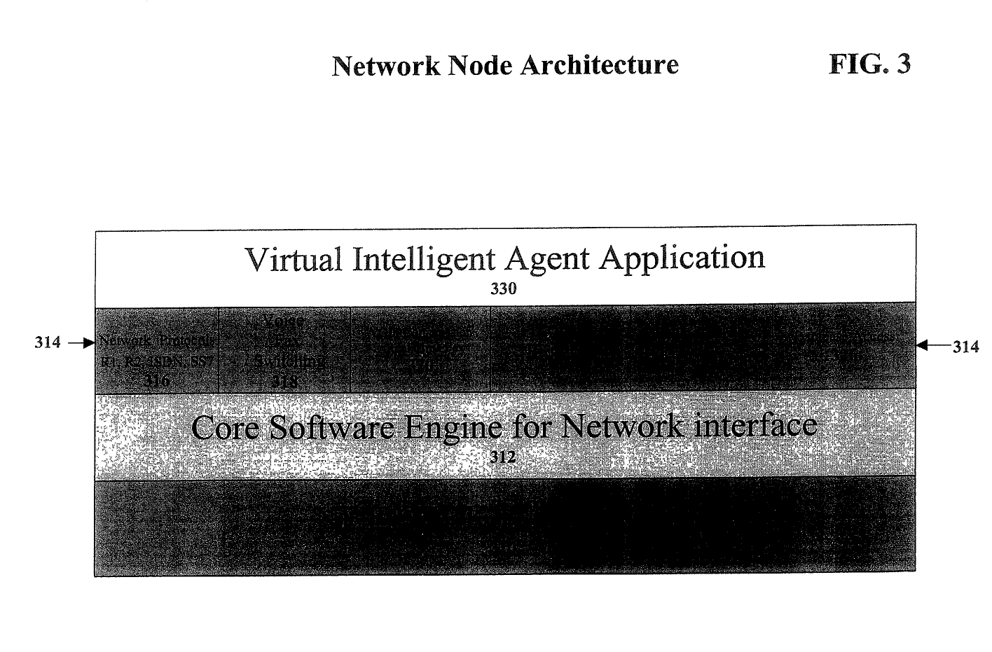

The more complex elements of the IP communications system 200, the gatekeeper 226, network node 240 and software client (on 238), will now be discussed in more detail. FIG. 3 divides the network node architecture into functional elements. At the bottom of FIG. 3, the “network interface” 310 represents the physical layer or interconnection between the packet-switched network and the PSTN. Commonly, this physical network interface 310 will be the telephone line cards of the network nodes (e.g., CG6000 telephony boards).

Above the physical network interface 310 is the core software engine 312 for the network interface 310. This core software engine 312 generally includes the various software drivers and other functionality to control the telephone line cards and telephony boards. For example, the core software engine 312 may provide individual controls for VoIP compression/decompression, for data encryption/decryption, to establish and send voice prompts, and to control other features of the telephony boards.

Above the core software engine 312 is another software layer 314 that preferably includes third party software packages and routines that enable IP communications functionality. For example, there may be the functionality to utilize various network protocols such as R1, R2, ISDN, and/or SS7 316. There may also be functionality to enable voice/fax switching 318. There is preferably a VoIP compression device with real-time fax capabilities 320. The system may also include a series of recorded voice prompts 322, such as “voice mail not available,” that the system may play for a caller or a user under certain circumstances.

There may also be an IP sockets/RTP/RTCP module 324 that allows quality voice signals to be sent over the packet-switched network even though the voice signals may be “bursty” by nature. This module 324 may include a buffer and sorter that reorders the sent packets as they are received and sends these packets as a datastream to the user. Finally, there is preferably a module 326 that allows access to the various system databases. For example, as previously described, there is preferably a subscriber database that allows the tracking and logging of subscriber activity and preferences.

The top layer 330 of the network node functional diagram (FIG. 3) is the software-based virtual intelligent agent application. The virtual intelligent agent software 330 integrates all of the other software (e.g., 312, 314) and hardware (e.g., 310) found in the network node together to enable system functionality.

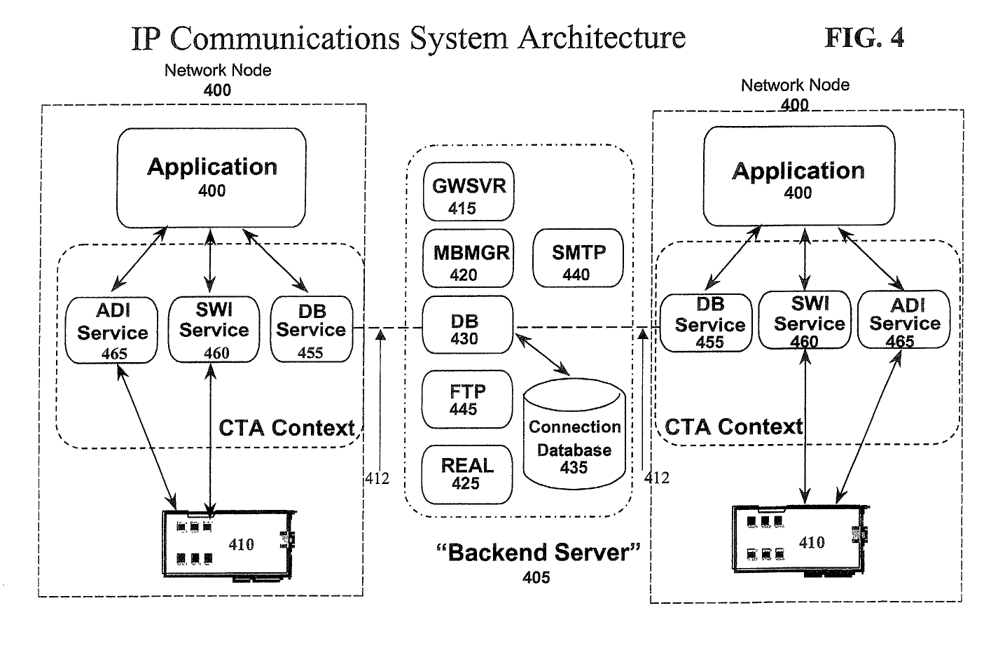

FIG. 4 displays an additional functional diagram of the IP communications network architecture as found in at least one embodiment of the present invention. This diagram generally indicates two network nodes 400 connected to one “backend server” 405 which includes one or more gatekeepers, media servers, databases, and other IP system components. As described above, there may be any number of network nodes 400 connected to the PSTN or to a particular local loop in the PSTN, and there may be more than one backend server 405 at each location. Preferably, there is at least one backend server 405 and at least one network node 400 connected to each local telephone loop to which subscribers to the present invention are connected. As more users utilize a certain part of the system, additional network nodes 400 may be inserted (usually on the fly) to service these additional users. The additional network nodes 400 would preferably include additional trunk cards 410 for communicating with the PSTN or other circuit-switched network.

The backend server 405 includes most of the IP-side functionality of the system. The backend “server” 405 may be just one computer with assorted functional features, but the backend server 405 is preferably a combination of servers, databases and other devices that are connected by a high speed communication medium such as a high bandwidth Ethernet pipe 412. In FIG. 4, the backend server 405 includes the gatekeeper (GWSVR 415), a mailbox manager 420 (notification server) and a REAL media server 425 (or other multimedia server) which enables the streaming of multimedia information to the software client.

The backend server 405 also preferably includes one or more databases 430 (DB) that include information for tracking the accounts, preferences, dynamic IP addresses and calls of the subscribers. There may also be a connection database 435 that aids in other administrative tasks. The backend server 405 preferably includes SMTP 440 or other electronic mailing functionality to aid the user in the storage and transmission of electronic messages via email. There may also be an FTP module 445 or other file transferring module that enables the transmitting of a received facsimile or other electronic document to the user on his or her software client.

This backend server 405 is preferably connected to one or more network nodes 400 through a high speed communications medium such as a high bandwidth Ethernet pipe 410 (which is typically connected to the Internet). The network node 400 consists of both hardware and software that allows the packet-switched, IP-switched network to communicate with a circuit-switched network such as the PSTN. The network node 400 includes one or more trunk cards 410 that provide physical communication between the networks.

The network node 400 also preferably includes a database service 455, a switching service module (SWI) 460 and a PSTN call setup service (ADI) 465. The database service 455 allows the network node 400 to interact with the various databases (e.g., 430) in the backend server 405. The SWI 460 and ADI 465 services are common software interface modules.

As described above, the gatekeeper facilitates the interconnection and communication between the software client connected to the public Internet, local intranet or other IP-based network, and the network node connected to the PSTN. This functionality provides not only a communication and interpretation methodology, but also facilitates many aspects of the present invention.

The gatekeeper is the initial server entity with which the client's own IP devices and network nodes interact. Client logons/logoffs are performed via the gatekeeper. Clients that are logging on have to supply their subscriber identifier and password. During the login process, the gatekeeper authenticates the user and registers the client dynamic IP address in the database. In this way, the system has a database record that matches a user's subscriber number to the user's dynamic IP address during that particular IP session. Typical users of the system will access the Internet through an ISP and be assigned a different IP address during each session. The gatekeeper tracks these dynamic IP addresses. Upon logging off, the gatekeeper “unregisters” the client's IP address from the database. Basically, the gatekeeper keeps track of “where” (in the IP address world) you are so that the system can ring you appropriately when calls are received. If a call is received and no dynamic IP address is found for the callee subscriber in the database, the system will know that the callee is not logged into the IP network and may try to transfer the call out to the PSTN or prompt the caller to leave a message, according to the callee's predefined preferences.

The gatekeeper also allows the clients to query for missed calls, voice mails or faxes; it supplies the necessary information in the event of a retrieval. Clients further initiate outgoing calls through the gatekeeper. The server will query the database on behalf of the calling client and will supply it with the IP addresses of the destination client and gatekeepers. Apart from these main communications functions, the gatekeeper may also assist the users in changing certain user options (preferences), in upgrading the client software, and other administrative tasks.

The gatekeeper handles requests from clients using a fully multithreaded model. It is preferably capable of serving simultaneous requests from multiple clients at the same time. Multiple gatekeepers may be deployed in clusters to handle heavy loads as well as to improve server redundancy. Therefore, if one gatekeeper malfunctions, a redundant gatekeeper server can pick up the extra user load. Also, these gatekeepers need not physically exist near one another. The servers are preferably all in communicative contact with each other through a high speed transmission medium, and the gatekeepers may exist in various places around the world to better serve local customers of the IP communications system.

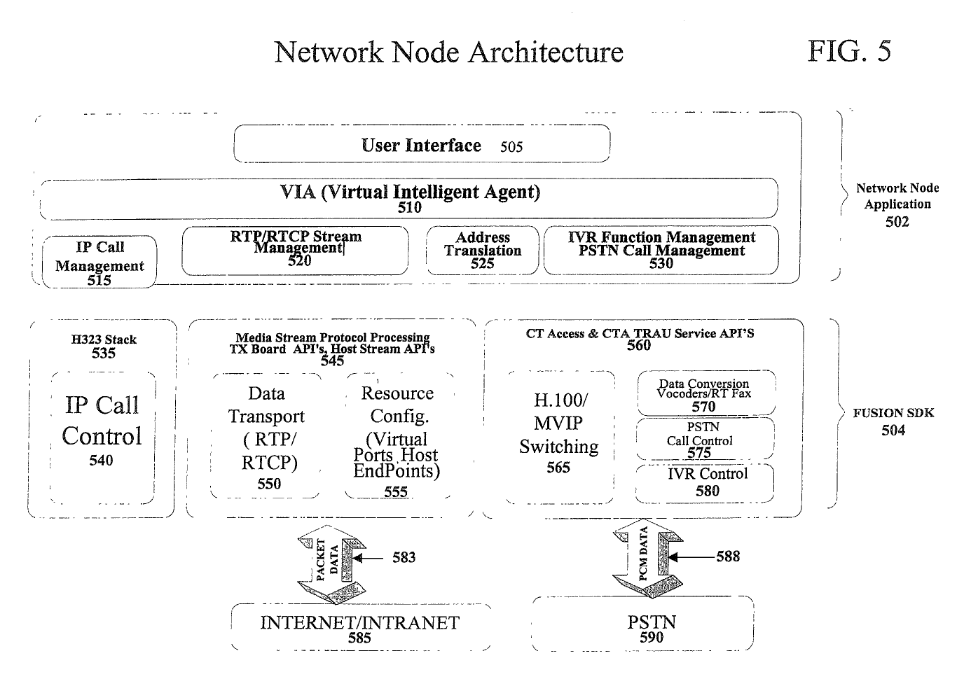

A more detailed description of the network node architecture is in FIG. 5. At the top of the network node architecture diagram (FIG. 5) is a user interface module 505. The user interface 505 preferably provides an outside environment for developers to upgrade or add functional additions to the IP communications system. This user interface 505 may be both a physical point of access into the system for add-ons, or a software socket for new program information. Preferably, these add-ons and developments may be incorporated into the network node while the network node is operational.

There may also be a virtual intelligent agent module 510 that provides functionality to the various telephony boards and software modules.

The network node application section 502 of the network node architecture diagram (FIG. 5) may also include several functional software and/or hardware modules. For example, there may be an IP call management module process 515 that rings a user's IP device upon receiving an incoming call. There may also be an RTP/RTCP stream management module 520 that allows an uninterrupted voice stream to reach the user even though the Internet is packetized and bursty in nature. This occurs even under heavy Internet traffic conditions. This module 520 preferably handles the QOS streaming which can ensure a quality voice signal in such a bursty environment.

The application section 502 of the network node may also include an address translation module 525 that handles the registration of an IP address to its corresponding user. This module 525 may authenticate or validate a user by checking his or her current IP address against a stored IP address for that user. Generally speaking, when an incoming call reaches the network node, it will locate the gatekeeper which will look up the dynamic IP address from the database for that user, check to see if the user is logged on, and then authenticate the user against the stored IP address. Finally, the application side 502 of the network node may also include an IVR function management and PSTN 530 call management module that retrieves the stored voice mails and faxes for a user when they log on and directs the flow of all the stored prompts and messages. More will be said about this below.

The network node also has software developed using the Fusion SDK (Software Development Kit) or other software development tools 504 that includes modules that facilitate interaction with the Internet/intranet (as packet data 583) as well as the PSTN (PCM data 588). The Fusion SDK-developed modules 504 may include an IP call control module 540 including an H.323 stack 535. This module 540 enables the network node to setup and place a call as well as to receive incoming calls. The Fusion SDK layer 504 may also include media stream protocol processing TX board APIs and host stream APIs 545 to facilitate the transfer of various data packets 583 over the IP network 585. These modules 545 preferably handle all of the subscriber ports associated with the network node's interconnection with the IP network 585. This module 545 may include data transport (RTP/RTCP) 550 as well as resource configuration (subscriber ports, host endpoints) 555. This port is communicatively connected to the Internet/intranet or other packet-switched network 585 to which users (clients) are connected.

The final section of the Fusion SDK-based applications 504 includes the CT access and CTA TRAU service APIs 560. These modules 560 generally allow for call control and ending over the PSTN network. This module 560 may include an H.100/MVIP switching module 565 which is the engine that allows the “hot plugging” of components while the system is running. This module 560 may also include data conversion vocoders/RT fax modules (codecs) 570. This module 565 may also include PSTN call control 575 and IVR control functionality 580. Generally, these modules as a group allow the network node to communicate with and send PCM data 588 over a circuit-switched network such as the PSTN 590.

As described above, these network nodes are preferably distributed over various geographic regions to better serve various subscribers. Preferably, there is at least one network node connected to the local telephone switch (local loop) to which each subscriber to the system is connected for regular telephone service. With this dispersed network node architecture, subscribers in various geographic regions will be able to utilize the system fully (e.g., with an IP device to IP device call) without necessarily interacting with the circuit-switched network.

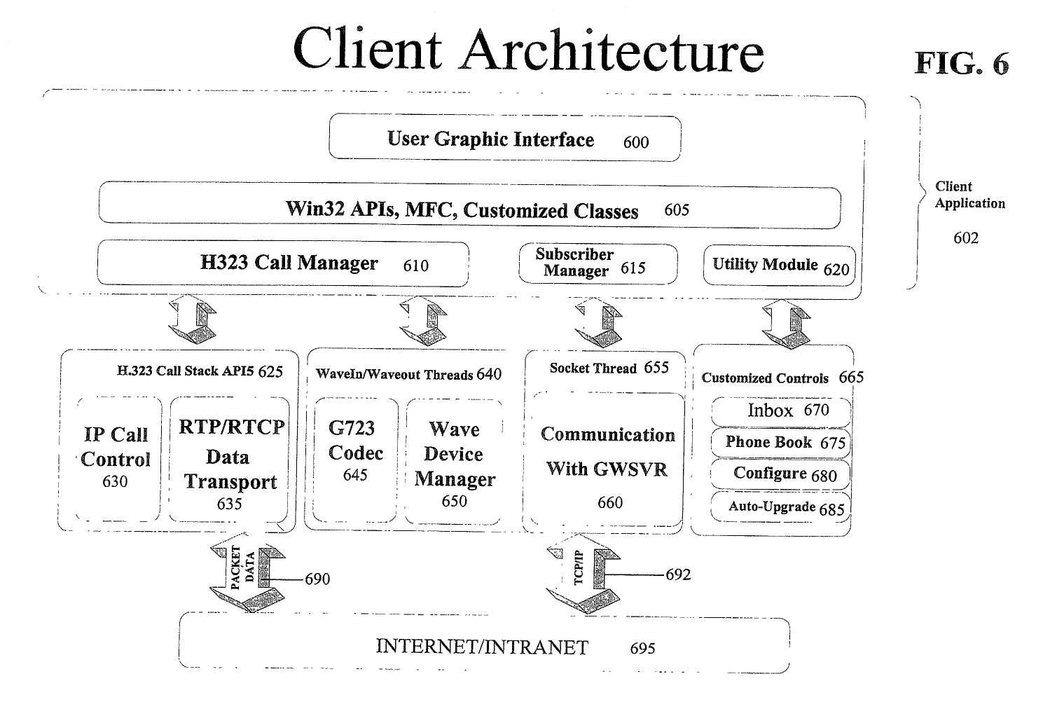

FIG. 6 details a functional diagram of the hardware and software on the multimedia software client. At the highest level, the software client includes a user-friendly graphical user interface 600 that aids in the placing and logging of telephone calls and faxes. This interface software preferably runs in a Win32 API environment which may include MFC and customized classes 605 developed as part of the present invention.

This client architecture also preferably includes functional modules that allow communication between the client IP device and the gatekeeper over the Internet, intranet, or other IP-switched network. For example, there is preferably an H.323 call manager 610 that handles all of the inbound and outbound call routines and the RTP/RTCP data transports. There may also be a subscriber manager module 615 that interacts with the gatekeeper to determine whether or not a user with a particular IP address is logged on. There may also be one or more utility modules 620 that provide ease-of-use and functional aspects to the client software.

The H.323 call manager 610 is preferably connected to an H.323 call stack API 625 and wavein/waveout threads 640 that control the flow of packet data 690 over the IP network 695. For example, there may be an IP call control module 630 and an RTP/RTCP data transport module 635 that facilitates this data communication. Preferably, there is a data buffer between the H.323 call manager and the H.323 call stack to make sure that the “bursty” voice packets have time to be properly re-aligned so that the sound is continuous. Because IP packets may arrive out of order and at different times, the data packets are preferably delayed on the order of hundreds of milliseconds to give the system time to rebuild the voice stream.

The wavein/waveout threads 640 may include a G723 codec module (coder/decoder) 645 and a wave device manager 650 that allows the voice signals in wave format to be sent and received. The user interface may also include a signal display so that the user can view the shape of the voice signal.

The subscriber manager 615 is preferably connected to a socket thread 655 that directs the communications with the gatekeeper 660. These communications preferably take place using the TCP/IP protocol 692. The communications include the gatekeeper's query as to the client's IP address as well as whether or not the client is currently logged into the system.

The utility module 620 is preferably connected to a variety of customized control modules 665 including an inbox 670, a phone book 675, a configuration module 680, and an auto-upgrade module 685 that checks to see if a newer version of the client software is available on the system. These functionalities will be discussed in more detail with respect to the user interface.

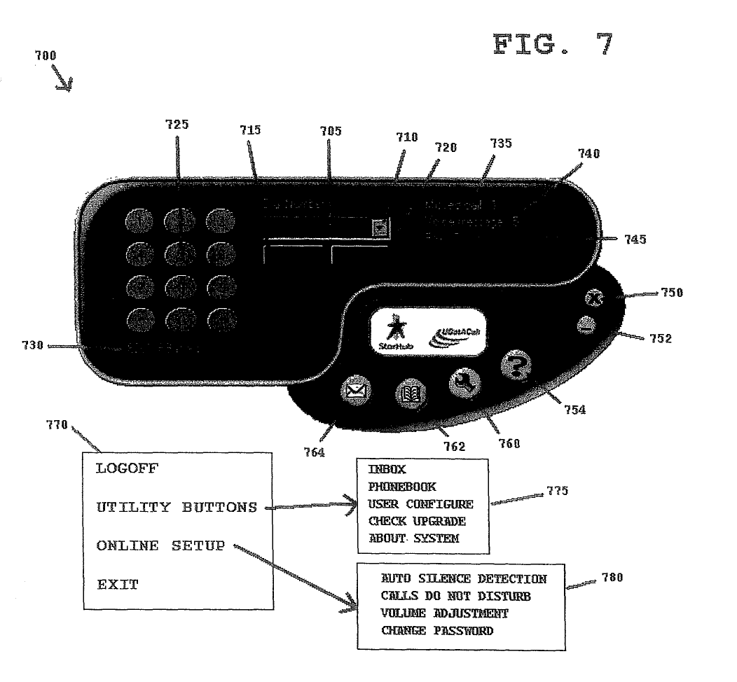

FIG. 7 details one example embodiment of a graphical user interface (GUI) 700 for use with the present invention. The GUI 700 generally provides a subscriber to the system with an easy and efficient interface through which to take advantage of the various features of the present electronic communications systems. The subscriber generally navigates around and provides information to the GUI 700 by way of a computer mouse, keyboard or other input device. The GUI 700 is preferably part of the client software running on the subscriber's IP device.

The GUI 700 may generally include a system identifier (e.g., a telephone number) window 705 which displays the subscriber identifier of the other party during incoming and outgoing calls. There may also be a drop down menu which displays a call history, or recent called/calling subscriber identifiers 710. This list may include the functionality to allow the user to select the number with the mouse pointer and automatically call these other parties.

When placing an outgoing call, the subscriber preferably types the subscriber identifier or telephone number in the display window 705 with the keyboard or by selecting the numbers on a virtual keypad 725. The subscriber may preferably choose to dial 715 the number or clear 720 the window 705 to type in a different subscriber identifier.

The GUI 700 also preferably contains certain status information about the subscriber's current session. For example, there may be a status bar 730 indicating the login status and subscriber identifier of the current system session. There may also be a bank of indicators that notify the user how many missed call events 735, voice mail messages 745 and/or facsimiles 745 are waiting for the subscriber in his or her inbox. These indicators are preferably updated by the notification server when the user logs into the system. The indicators 735, 740, 745 generally provide the subscriber with status updates.

The GUI 700 may also include one or more standard “WINDOWS” functions that allow the user to manipulate the GUI 700 in the same way as other graphical software. For example, there may be an “exit” button 750 or a “minimize” button 752. There may also be a “help” button 754 that provides the user with immediate or on-line information to aid the user in using the GUI 700 and the communications system in general.

The GUI 700 may also have an address book function 764 that allows the user to store frequently called numbers and subscriber identifiers. The entries in the address book 764 preferably allow the user to store the name, subscriber identifier or telephone number, and other information about each entry in the address book. Using the address book 764, the user may be able automatically to call a subscriber or other party by “clicking” on the party's name or identifier in the address book 764 list.

The system may also have an inbox 762 which stores all of the voice mail messages, facsimile messages, and/or missed called events in one combined list of information. Preferably, the inbox 762 details what type of event was received, when it was received, from whom it was received, and the length of the message, if any. To retrieve a received voice mail message or facsimile, the subscriber preferably need only “double-click” or otherwise select the entry in the inbox 762. The client software then preferably opens up the appropriate fax viewer (.tif viewer) or streaming media player to view the fax or listen to the voice mail message. These messages may be replayed, stored, forwarded and otherwise manipulated by the subscriber.

The inbox 762 may also have an automatic callback functionality for the entries in the inbox 762. For example, to call back a person who called but did not leave a message (a missed call event), the subscriber preferably need only double-click or otherwise select the missed call event from the inbox 762 list of entries. This same callback functionality may also enable the automatic callback of parties who leave fax and voice mail messages.

The GUI 700 may also provide the functionality for users to define certain system preferences from the GUI 700. For example, there may be a series of mouse menus (or other selectable features) that may be chosen and altered by the subscriber. For example, “right-clicking” on the GUI 700 or otherwise selecting to see a menu of options, may provide a selection menu 770. This menu 770 may allow the user to logoff, exit, or select from a further list of utility button options and/or online setup options.

The utility button options 775 may provide the subscriber with certain use and upgrade options. For example, the subscriber may be able to access and edit his or her phonebook and inbox from the menu 775. The subscriber may also be able to automatically look for a newer version (upgrade) of the client software on the Internet, or the subscriber may be able to find further information about the current version of the client software. Finally, there may be one or more “user configure” options that allow the user to change login options, the facsimile data storage path, or other configurable options.

The online setup menu 780 preferably includes various options to configure and set up the GUI further in accordance with the subscriber's preferences. For example, there may be a volume adjustment or the ability to change the subscriber password (or PIN). There may also be a “do not disturb” button that disables the “ringing” feature of the client software. With “do not disturb” enabled, the subscriber may still see the notification indication about incoming call events, and the subscriber may also be able to place outgoing calls and facsimiles, but the subscriber will preferably not be bothered by incoming calls. The incoming calls will preferably be routed directly to the subscriber's voice mail or other messaging function.

Finally, the online setup menu 780 may allow for “auto silence detection” during voice calls. Because there is always some background noise during a telephone call, even when no party is speaking, the system may normally send these “hisses” across the communications system. Because the parties normally will not intend for this background noise to be sent, it is a waste of system bandwidth to send these packets. With auto silence detection, the system may stop sending packets if a predefined amount of time elapses during which the system detects only this background noise. Once a subscriber does begin to speak again, the system will preferably start sending data packets again.

The general components of the present invention are preferably designed to be scalable, redundant and adapted for rapid deployment and upgrading while the system is running. Components are preferably designed using industry standard technologies such as Signaling System 7; TCP/IP for data communications; and H.323, SIP or MGCP for call setup and control. The scalability will provide for seamless addition of new services. As current network nodes and server components run near their maximum throughput, additional nodes and servers may be added to the system. As the new systems are added, all of the nodes and servers should be programmed to share the load of data transfer more evenly, rather than fully using one server while another stays idle nearby. These components should also be rapidly deployable in that additional components can easily come on-line while the system continues to operate. This may be facilitated by using a programmable state machine using a simple scripting language (e.g., LUA).

The components also preferably utilize open architecture components wherever possible. By opening the architecture, the potential for additional, “value-added” services to be generated is greatly enhanced. With an increased number of developers involved, the system will gain popularity and use more quickly. Sources of open architecture features including using an industry standard bus (e.g., compact PCI), using the Linux operating system or other open source software for backends, running the gatekeepers on Solaris workstations, and utilizing ACE libraries.

Although not essential, the servers and other equipment may also be placed in front-open (easy access) cabinets with both ESD and EMI protection circuits used. Preferably, even the standard computer components, such as disk drives, power supplies, and trunk cards, are all “hot pluggable” in that they can be removed, upgraded, and/or replaced without powering down the system or the system component.

The system may also include custom call scripting that facilitates user-configuring of various features of the IP communications system. For example, a user may script an icon to play a message (e.g., “I'll call you right back.”). This scripting may also allow the user to change his/her voice mail announcement.

3. Methodology Examples

The above hardware and software descriptions schematically divide the present invention into functional components. To aid in comprehension of the present invention, several exemplary “scenarios” of use of one embodiment of the present invention will now be detailed. As above, these scenarios are for purposes of example only, and should not be used to limit the present invention.

The first example describes a person registering to use the IP communications system for the first time and thereafter receiving a call from another person. The user preferably has an IP device running a common operating system such as Windows 98, NT, 2000, ME or CE. The user may register for the system, either by telephone or through the World Wide Web (the “web”). The IP communications system will assign the user a unique subscriber identifier, which is often a telephone number (VIA number or “subscriber number”) and a PIN (personal identification number) to be used as a password. Because the present invention can be used with both the PSTN and the IP-switched network, the subscriber number assigned to the user preferably corresponds to the format of telephone numbers in the PSTN where the user resides (e.g., numbers in the U.S. would have a corresponding area code). This facilitates seamless switching between the IP-switched and PSTN networks. The PIN may preferably have at least six digits and is used for authentication and security.

After being assigned a subscriber identifier and a PIN, the user preferably installs the client software from a disk or installs the software directly from a web page sponsored by the IP communications system. Alternatively, the IP device may come with the client software preinstalled. The installation program may use an auto-install aid, such as an “Install-Shield Wizard” for use with common operating systems. When the user wishes to log onto the system, the user will start the program on his or her IP device at which time the user interface will appear on the user's display.

During this initial logon, the system will prompt the user to input his or her subscriber identifier and PIN. The client software includes a registration table that directs the software client to a specific gatekeeper from which the user can log onto the IP communications system. This gatekeeper is preferably connected to the Internet, a local intranet, or some other IP network to which the user is also connected. Most often, the user will use an Internet Service Provider (ISP) to connect to the public Internet with which the gatekeeper will also be connected. Preferably, the user will always be connected to the system through the same gateway in future sessions.

Based on the registration table, the client software will send a message to the appropriate gatekeeper including the user's subscriber identifier and PIN and request that the user be logged into the system. The gatekeeper queries the database to determine if the proposed subscriber identifier and PIN represent a valid subscriber. If the gatekeeper named in the registration table is not operating properly, there may be additional gatekeepers daisy-chained together the handle the database query. This is one of the many redundancies that may exist in the present system. Once the gatekeeper verifies the validity of the user, the user is logged onto the system. The gatekeeper will also query the software client for the dynamic IP address of the IP device on the packet-switched network and enter the user's current dynamic IP address (which typically changes each time the user logs into the packet-switched network) into the database for use by various features of the system.

The network nodes, that sit between the PSTN and the Internet, contain telephony boards with ports to handle telephone and IP calls. The local PSTN exchange is programmed such that it will route calls placed to the user's subscriber identifier to the appropriate network node, or a series of network nodes coupled together. This automatic routing is the reason the subscriber identifier should correspond to the particular dialing practices of the public telephone system in the locality of the user.

When a caller places a call from a conventional telephonic device to the user's subscriber identifier (number), the call gets routed by the PSTN to the appropriate local loop of the PSTN where the user resides. At this point, the network node attached to the local loop takes the call off of the PSTN network and requests the gatekeeper (assigned to that subscriber identifier) to check the database to determine if this user is currently logged into the packet-switched network. If the gatekeeper finds that the user is logged onto the system, the gatekeeper will look up the user's current dynamic IP address and perform an authentication socket call to the user's software client. In this socket call process, the gatekeeper will request the subscriber identifier and PIN (password) from the software client. If the software is running on the software client, the software will activate itself upon receiving the socket call and determine if the proper subscriber is on that particular client (i.e., authenticate the subscriber identifier and PIN). The client software will then send a confirmation or acknowledgment back to the gatekeeper of the user's identity and validity.

This confirmation performs an authentication process to prevent unauthorized users from using the system on a software client. For example, if a subscriber is using the system and forgets to logout of the system after a session, and another person thereafter logs onto the Internet and runs the client software on the subscriber's IP device, the client software will not allow the IP device to ring when called because the “new” dynamic IP address (assigned to the second user) will not match the IP address stored in the system's database (from the subscriber's last session). The client software will notify the gatekeeper that an incorrect user is logged into the system.

After the registration/authentication process, the gatekeeper signals to the network node that the user is logged in, and the network node sets up an H.323 (or SIP, MGCP) call session for the user. The network node will setup an H.323 call with the client. This H.323 session notifies the client of the incoming call and identifies the subscriber number or other identifying information about the caller. The client receives this information, pops the software application onto the user's display, and signals the user through his IP device (e.g., with an audible “ringing” sound or vibration). The software application window will preferably identify the caller and inquire as to whether the user would like to accept or “reject” the incoming call (e.g., using mouse-based control buttons). This effectively performs a call-screening function.

If the user elects to accept the call, for example by clicking with a mouse on a dialog button, the client software will signal the network node that the call has been accepted, and the network node will set up a call session between the caller's telephone and the user's IP device. The network node effectively acts as an interpreter or data converter during the call session. The voice data comes into the local telephone system as voice data on the PSTN, and the network node converts the voice data into packet data to be sent to the software client (over an IP-switched network). The client software will collect the data packets, sort the packets into their correct order, and play the caller's voice on the software client (utilizing the sound card and speakers of the software client). The network node preferably performs data compression and decompression (coding/decoding) while packetizing the voice information for distribution to the software client. This compression/decompression allows compressed data to be sent over the network thereby allowing a low bandwidth connection to provide high fidelity recreation of the caller's voice signal.

The client software has additional buffering capabilities utilized when receiving the data packets from the network node. As the packets of voice information are received by the client software, they may arrive at the client in a different order than they were sent by the network node. The software client preferably utilizes a “jitter buffer” or other buffering technology to receive the packets (in any order), and analyze the packet packaging bytes to determine the proper order of the packets. Each packet can therefore be placed in the proper order, and, after a slight time delay, the stream of reordered packets can be played for the user without interruption. This buffering may impart a delay of up to approximately several hundred milliseconds.

If, during the authentication process, the gatekeeper is unsuccessful in finding the user logged into the network (because the user is either not logged into the Internet or the client is unavailable for some other reason), the gatekeeper and the network node will enter “call completion mode” and determine how to handle the call. In one embodiment of the present invention, the gatekeeper will signal to the network node that the caller is not available, and the network node will play an audio message through the PSTN to the caller indicating that the callee is not available. The message may request that the caller leave a voice mail message for the callee or the message may provide further information (based on the user's preferences and pre-recorded voice prompts which are preferably stored in the network node or an accompanying database). If the caller chooses to leave a message, the network node will record the voice message and preferably store the voice message in the database for future playback by the callee. The network node will also preferably signal the notification server to notify the user that a voice mail message is waiting for the user in the database. In this way, the next time the user logs onto the system (and the notification server is activated by the gatekeeper), the user will be alerted that a voice mail message is waiting.

The notification server may be programmed with several different notification options. Preferably, the user is able to set these various options using the client software. For example, the notification server may wait for the user to log back into the system before notifying the user via his IP device. The notification server may also be programmed to call the user on his mobile telephone, text or voice pager, PDA, or some other electronic communications device.

The notification server may also be set up to forward the call rather than prompt the caller to leave a voice mail message. For example, when the gatekeeper determines that the user is not logged into the system, the notification server may signal to the network node that the call is to be forwarded to the user's mobile or land-based telephone number. Therefore, without the caller performing any additional steps, the call may be forwarded to this outside phone number. The network node will preferably forward the call back out to the PSTN and ring the user at his desired forwarding phone number. In this way, although the caller called the user on a number identified with the IP communications system, the user may receive the call on his mobile or other phone or pager, all preferably without the caller being aware of the forwarding process. This seamless integration of the circuit-switched PSTN and the packet-switched IP network may provide a more convenient way to reach callees.

If the user cannot be found and all call forwarding options have been exhausted, the caller is preferably prompted to leave a voice mail message. If the caller chooses not to leave a voice mail message, or if the call is dropped before completion, the notification server is preferably programmed to notify the user that a “missed call event” has occurred. Although no voice mail message is waiting, the notification server preferably indicates to the user, as part of the client software, that a call was received but not completed since the user was last logged into the system. The notification server preferably includes the telephone number or subscriber identifier of the caller to aid in the user's ability to call the caller back at some time in the future. The callee's client software may also have an automatic callback feature, allowing the callee to initiate an immediate callback.

Similarly, if the caller sends a fax to a subscriber of the IP communications system, the caller will send the fax according to standard faxing procedures. As the fax call is routed to the subscriber's number, the PSTN again recognizes the subscriber number as being mapped to a particular network node (or series of network nodes). When the network node receives the fax call, the network node “listens” for several seconds when the call first comes into the network node. If the network node receives a fax tone, i.e., the series of squelches or CNG tones characteristic of an incoming fax, the network node will recognize the call as containing a fax message and will return the appropriate “return fax tone” to the caller's fax machine (as is common practice with conventional fax procedures).

After responding to the caller's fax machine, the network node will enter a “deposit mode” whereby the fax message is received by the network node and stored in the database for future downloading by the software client. After the fax is received, the network node preferably completes the call according to standard fax practices and signals the notification server to notify the user that a fax has been received. Accordingly, the notification server may determine if the callee subscriber is on the Internet or not, and is able to send a notification to the user via the client software. If the subscriber is on the system, or during the subscriber's next session on the system, the client software preferably has the ability to indicate that a fax was received by the system. The subscriber can then retrieve the fax via a .tif file viewer or other conventional fax viewing software.

In one preferred embodiment of the present invention, the method for sending an outgoing call from the IP communications system to another person is generally the reverse of the procedure just described for incoming calls. The user types in, or otherwise enters, a destination identifier (either conventional PSTN number or subscriber identifier) to be called. The client software sends this call information to the subscriber's gatekeeper, and the gatekeeper may re-authenticate the subscriber to make sure that he or she is a valid subscriber.

The gatekeeper will then check the database to determine if the number being called belongs to a valid subscriber and whether, if that number belongs to a valid subscriber, that subscriber is also logged into the Internet by searching the database for a dynamic IP address associated with the subscriber number. If the callee subscriber is logged into the Internet, the gatekeeper will retrieve the callee subscriber's IP address from the database (which was entered in the database when the callee subscriber logged into the system). The gatekeeper will return the callee subscriber's IP address to the caller subscriber's client software so the call can be placed. Because both subscribers (caller and callee) are currently logged into the system, the call may be placed over the Internet (IP-switched), rather than having to go at least partially across the PSTN (circuit-switched). Therefore, the caller client software will preferably not go through the network node to place the call, because no translation from the IP network to the PSTN need take place. Instead, the caller's client software will setup an H.323 (or SIP, MGCP) call session to ring the callee subscriber at his IP address.

When the caller subscriber's client software sets up the H.323 session and rings the callee subscriber, the gatekeeper will again attempt to authenticate the callee subscriber to make sure that the person at the designated IP address is in fact the person whom the caller subscriber is attempting to call. This authentication occurs by the gatekeeper performing a socket call to the callee client software and checking the response with the database information for that client. If the client software does not respond correctly (e.g., the database had an incorrect or old dynamic IP address for the callee subscriber, the call is routed to the network node assigned to the callee subscriber. This network node enters “call completion mode” for the callee subscriber and determines how to handle the completion of the call. For example, as described above, the network node may transfer the call to one of the callee's PSTN numbers and ring the callee's mobile phone, landline phone or pager. Alternatively, the network node may play a “please leave a voice mail” message back to the caller subscriber. The callee's network node may then record the voice mail message to the database for future access by the callee, and the callee's notification server is preferably signaled to notify the callee subscriber when next the subscriber logs into the system.

A similar circumstance arises when a subscriber of the IP communications system calls another subscriber of the IP communications system, but the two subscribers exist on two separate, but interconnected, networks (A and B). In one preferred embodiment, the present invention facilitates a seamless interconnection of these two networks. In this case, the caller client software and the caller gatekeeper are preferably able to locate an IP address for the callee, even though the callee is on a different network. For example, when the caller (on network A) attempts to make a call to a callee subscriber on network B, the caller client software will tell the caller's gatekeeper to locate the appropriate IP address for the callee. The gatekeeper will check the database and determine that the callee is a valid subscriber, but that the caller belongs to a separate network, and cannot therefore determine the callee's IP address. The gatekeeper will, however, determine that the callee's subscriber number belongs to network B, and the gatekeeper will be able to look up a DNS (Domain Name Service) address for network B. The gatekeeper preferably sends the network B DNS back to the client software which then accesses the network B DNS and asks for an IP address for the callee's number.

The client software will then attempt to contact the callee subscriber at that IP address and determine whether or not the callee is on the Internet. If the callee subscriber is on the Internet, the gatekeeper on the callee's network (B) can set up a direct H.323 session (or other call session) between the caller and the callee. If the gatekeeper on network B determines that the callee is not on the Internet or is somehow otherwise unavailable, the network B gatekeeper node will transfer the call to the network B network node in call completion mode. The network B network node will then determine how to complete the call (e.g., call forwarding, missed call, voice mail) according to the practices outlined above. Any voice mail messages and other information is preferably stored at a database connected to network B, where it can be retrieved by the callee the next time the callee logs into or calls the system. A notification server on network B will notify the callee.

A preferred embodiment of the present invention also allows a subscriber to the system to call a non-subscriber from their IP device using the client software. The call begins like every other call: the user dials the callee's phone number in the client software and the dialing information is sent to the caller subscriber's gatekeeper to determine if the callee is a valid subscriber. In this case, the gatekeeper will determine, through polling the database, that the callee is not a valid subscriber. The gatekeeper will then transfer the call to the network node and tell the network node to place a “regular” telephone call over the PSTN. Therefore, the network node will send the call out over the PSTN and ring the callee on his telephone (e.g., mobile or landline) and complete the call as a regular telephone call. Throughout the call process, the network node acts as an interpreter between the PSTN and the packet-switched local network. To the subscriber, the call appears seamless, regardless of the whether the callee is a subscriber who is logged into the system, a subscriber who is not logged in, or a non-subscriber who is on a regular telephone.

The examples and embodiments of this invention can also utilize various wireless technologies, both IP-based and PSTN-based. Users from various disparate geographies can communicate in a limitless array of circuit-switched and packet-switched schemes, all with near seamless integration.

Nothing in the above description is meant to limit the present invention to any specific materials, geometry, or orientation of parts. Many part/orientation substitutions are contemplated within the scope of the present invention. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

What is claimed is:

1. An electronic communications system with at least one user, comprising:
a gatekeeper in electronic communication with a packet-switched communications network, wherein said gatekeeper is capable of associating a user's subscriber identifier with a dynamic Internet Protocol address for the user; and
a network node in electronic communication with a circuit-switched communications network and the gatekeeper, wherein said network node is capable of transmitting data over both the circuit-switched and the packet-switched network.

2. The system of claim 1, further comprising:
a subscriber database, wherein said subscriber database comprises data that matches at least one user's subscriber identifier with a dynamic Internet Protocol address for the user.

3. The system of claim 1, further comprising:
client software, wherein said client software is adapted to communicate with said gatekeeper over the packet-switched network.

4. The system of claim 3, wherein said client software is adapted to communicate the dynamic Internet Protocol address and subscriber identifier of a user to the gatekeeper.

5. The system of claim 3, wherein said client software comprises a graphical user interface adapted to allow a user to reject an incoming call.

6. The system of claim 3, wherein said client software comprises a graphical user interface including an auto-upgrade feature.

7. The system of claim 3, wherein said client software comprises a graphical user interface including an inbox to retrieve incoming messages.

8. The system of claim 7, wherein said inbox is adapted to allow a user automatically to call back a caller who is represented in said inbox, said user performing a single action to call back the caller.

9. The system of claim 3, wherein said client software comprises a graphical user interface including a do not disturb feature.

10. The system of claim 3, wherein said client software comprises a graphical user interface including an auto silence detection feature.

11. The system of claim 1, further comprising a media server.

12. The system of claim 1, further comprising a message notification server.

13. The system of claim 12, wherein said message notification server is adapted to notify a user that a facsimile message was received.

14. The system of claim 12, wherein said message notification server is adapted to notify a user that a voice mail message was received.

15. The system of claim 12, wherein said message notification server is adapted to notify a user that a missed call was received.

16. The system of claim 1, wherein the circuit-switched communications network is the public switched telephone network.

17. The system of claim 16, wherein said subscriber identifier is a telephone number that corresponds to the local dialing practices of the public switched telephone network.

18. The system of claim 1, wherein the packet-switched communications network transmits data packets according to the Internet Protocol.

19. The system of claim 1, wherein the packet-switched communications network is an intranet.

20. The system of claim 1, wherein the packet-switched communications network is the Internet.

21. The system of claim 1, wherein said network node comprises call scripting functionality.

22. The system of claim 21, wherein said call scripting functionality comprises user-definable voice messages.

23. The system of claim 22, wherein said messages comprise a voice mail announcement.

24. The system of claim 22, wherein said call scripting functionality comprises user-definable call routing options.

25. The system of claim 1, wherein said gatekeeper is adapted to authenticate a user when said user logs into the system.

26. The system of claim 1, wherein said gatekeeper is adapted to authenticate a user when said user places an outbound call.

27. The system of claim 1, wherein said gatekeeper is adapted to authenticate a user on an IP device when said user receives an incoming call.

28. The system of claim 1, wherein said gatekeeper is adapted to remove the association between the dynamic Internet Protocol address and the subscriber identifier of a user that has logged out of the packet-switched network.

29. The system of claim 1, wherein said network node is adapted to re-route an incoming call placed to the user's subscriber identifier out over the circuit-switched network to a traditional telephone number according to the user's predefined call routing preferences.

30. An electronic communications system, comprising:
a gatekeeper in electronic communication with a packet-switched communications network;
a network node in electronic communication with a circuit-switched communications network and the gatekeeper, wherein said network node is capable of transmitting data over both the circuit-switched and the packet-switched network, further wherein said network node is capable of determining whether said transmitted data represents a facsimile.

31. The system of claim 30, wherein said network node comprises means for detecting facsimile CNG tones.

32. The system of claim 30, wherein said network node is adapted to distinguish between facsimile data and voice data.

33. The system of claim 30, wherein said network node is adapted to wait for a period of time after receiving incoming data to determine whether said transmitted data represents a facsimile.

34. The system of claim 33, wherein said period of time is approximately two seconds.

35. An electronic communications system, comprising:
a gatekeeper in electronic communication with a packet-switched communications network;
a network node in electronic communication with a circuit-switched communications network and the gatekeeper, wherein said network node is capable of transmitting data over both the circuit-switched and the packet-switched network, further wherein said network node is adapted to accept a voice mail message; and
means for recording a voice mail message in a digital format.

36. The system of claim 35, wherein said means for recording is the network node.

37. The system of claim 35, further comprising:
a database capable of storing said voice mail message for later retrieval by a user.

38. The system of claim 37, wherein said later retrieval comprises the user accessing the system from a PSTN-based device.

39. The system of claim 37, wherein said later retrieval comprises the user accessing the system from an IP-based device.

40. The system of claim 35, further comprising:
a media server adapted to stream said voice mail message to a user.

41. The system of claim 40, wherein said media server streams said voice mail message in a streaming audio format.

42. The system of claim 35, further comprising:
a notification device for signaling an intended caller when said voice mail message is received.

43. The system of claim 35, further comprising:
means for sending said voice mail message as an email message.

44. The system of claim 39, wherein said IP device comprises client software utilizing a graphical user interface.

45. A method for transmitting data, comprising the steps of:
receiving a request to transfer data to a recipient, said request comprising a subscriber identifier for said recipient;
searching for a dynamic Internet Protocol address for said recipient associated with said subscriber identifier;
determining the appropriate communications channel to transmit the data based on the results of said searching step; and
transmitting the data to the recipient in response to said determining step.

46. The method of claim 45, wherein said request is received from an IP device.

47. The method of claim 45, wherein said request is received from a telephonic device.

48. The method of claim 45, wherein said data comprises a voice call.

49. The method of claim 45, wherein said data comprises a facsimile.

50. The method of claim 45, further comprising the steps of:
receiving a subscriber identifier and dynamic Internet Protocol address from client software running on an Internet Protocol device used by the recipient; and
storing said subscriber identifier associated with said dynamic Internet Protocol address in a database.

51. The method of claim 50, wherein said subscriber identifier and dynamic Internet Protocol address are received from the client software automatically in response to the recipient's activation of the software.

52. The method of claim 51, wherein said Internet Protocol device is communicatively connected to the Internet.

53. The method of claim 51, wherein said dynamic Internet Protocol address is assigned to the Internet Protocol device upon the recipient's logging into the Internet.

54. The method of claim 50, wherein said determining step comprises:
accessing the database; and
looking up the dynamic Internet Protocol address of the recipient's Internet Protocol device in the database.

55. The method of claim 45, wherein said step of transmitting the data to the recipient occurs exclusively over a packet-switched network in response to a found dynamic Internet Protocol address for the recipient in said searching step.

56. The method of claim 55, wherein said packet-switched network is the Internet.

57. The method of claim 54, wherein said step of transmitting the data to the recipient occurs over both a packet-switched communications network and a circuit-switched communications network in response to failing to locate the Internet Protocol address assigned to the recipient in said looking up step.

58. The method of claim 57, wherein said circuit-switched network is the public-switched telephone network.

59. The method of claim 45, wherein said transmitting step further comprises the step of:
ringing the recipient on an Internet Protocol device assigned to the dynamic Internet Protocol address of the recipient.

60. The method of claim 59, further comprising the step of:
receiving a response to a call acceptance query from client software running on the Internet Protocol device.

61. The method of claim 60, further comprising the step of:
recording a voice mail message for said recipient in response to said recipient failing to accept the call acceptance query.

62. The method of claim 61, further including the step of:
notifying the recipient that a voice mail message is waiting to be received.

63. The method of claim 60, further comprising the step of:
routing said data out over a circuit-switched network in response to said recipient failing to accept the call acceptance query.

64. The method of claim 60, further comprising the step of:
initiating a voice call with said recipient in response to said recipient accepting the call acceptance query.

65. The method of claim 64, wherein said call is set up using a protocol selected from the group consisting of H.323, SIP, and MGCP.

66. The method of claim 45, wherein said transmitting step further comprises the steps of:
determining whether said data represents a facsimile; and
storing said facsimile in a database in response to determining that the data represents a facsimile.

67. The method of claim 66, further including the step of:
notifying the recipient that a facsimile has been received.

68. The method of claim 45, wherein said subscriber identifier is a PSTN-based telephone number.

69. The method of claim 68, wherein said PSTN-based telephone number corresponds to the dialing practices of the local PSTN telephone exchange of the recipient.

70. A method for registering a dynamic Internet Protocol address to a subscriber, comprising the steps of:
assigning a subscriber identifier to the subscriber;
accepting the dynamic Internet Protocol address assigned to the subscriber in response to the subscriber's logging into a packet-switched network; and
registering the subscriber identifier to the dynamic Internet Protocol address in a database.

71. The method of claim 60, wherein said assigning step comprises assigning a password to the subscriber.

72. The method of claim 50, further comprising the step of:
unregistering the dynamic Internet Protocol address from the subscriber identifier in the database in response to the subscriber's logging out of the packet-switched network.

73. An electronic communications system comprising:
means for communicatively connecting a packet-switched communications network to a circuit-switched communications network;
means for determining the dynamic Internet Protocol address for a system subscriber; and
means for registering the dynamic Internet Protocol address for the system subscriber to a subscriber identifier for the system subscriber.

74. The system of claim 73, wherein said means for communicatively connecting is adapted to switch an incoming call to the circuit-switched network if no valid dynamic Internet Protocol address is registered to a called subscriber identifier.
